(19) United States
(12) Patent Application Publication
(10) Pub. No.: US 2007/0193415 A1
(43) Pub. Date: Aug. 23, 2007

(54) Power driven wine bottle opener

(76) Inventor: Eugene Eric Isaacson, Gwinn, MI (US)

Correspondence Address: EUGENE ISAACSON, P.O. BOX 1025 141 TAMARACK, GWINN, MI, 49841, US

(21) Appl. No.: 11/359,921

(22) Filed: Feb. 23, 2006

(51) Int. Cl. B67B 7/00

(52) U.S. Cl. 81/3.2

(57) ABSTRACT

This invention relates to a more economical and efficient removal of a wine bottle cork. It also aids in the ergonomics of the food handling industry, waiters, bar tenders, also people with physical disabilities such as arthritis and carpal tunnel syndrome may be able to open a wine bottle with less pain and fatigue.

### BACKGROUND

This invention would be a reliable low cost device unlike other motor driven battery operated co-operated devices that can cost up to $1,000.00 and or have power sources that have to be replaced increasing the operating reliability and maintenance cost.

### SUMMARY

The Power Driven Wine Bottle opener is simple and economical to manufacture resulting in lower purchase cost. Also it may be operated by an power source that is used for other tasks and is, presently owned, reducing the investment. The turning, twisting, pushing, and pulling is virtually eliminated. And when placed in a holder when cork ejection is initiated a 1 handed operation can be utilized.

### Power Driven Wine Bottle Opener

By Eugene Isaacson, a United States Citizen

141 Tamarack Street, Gwinn, Mich. 49841, USA

The Power Driven Wine Bottle Opener is operated by any reversible electric drill, pneumatic drill, electric screwdriver or a power source manufactured for the purpose of operating the power driven wine bottle opener. The Power Drive Wine Bottle Opener consists of 3 main parts a main body a slide body and an augar shaft. The augar shaft is installed in the slide body held in place by a secured bearing surface and a permanent bearing surface. The augar tip is placed on the top or the cork, then the power source is operated clockwise, the slide body is stopped by the main body, then with continued clockwise operation. The cork is pulled from the bottle by riding up the augar shaft. The cork is removed from the Power Driven Wine Bottle Opener when the power source is operated counter clockwise. A compression spring between the main body and slide body assist the removal of the cork. The opener may be manufactured from a variety of food grade materials and methods of manufacture such as weldment, machined from metals, composites, plastics may be injection molded or cast.

REFERENCES CITED:

| | | |
|---|---|---|
| #5079975 | January 1992 | Spencer |
| #5095778 | March 1992 | Bocs1 Et.Al |
| #5724869 | May 1998 | Robert A. May |
| #6101899 | August 2000 | Dusan Nikolic |

A rotating power source is coupled to the top of the augar shaft 1 a clockwise motion is initiated. The augar shaft 1 is screwed thru the cork with the permanent bearing surface of the augar shaft 1 pulling the slide body top plate 2 and slide rails 4 & 5 to the main body 6, compressing the compression spring 3, the rotation continues until the cork rides up the augar shaft, the cork holding rails 7 and 8 hold the cork from not turning with the augar shaft 1 the cork continues up the augar shaft 1 until it is removed from the bottle. The main body 6 is then held or placed in a support and the rotation is reversed. The compression spring 3 pushes the main body 6 and slide body 2 and slide body rails 4&5 apart forcing the cork to screw of the augar shaft 1 slide rail housing 9 & 10 are installed to protect moving parts slide rail retainers 11 & 12, will not allow the L shaped slide rails 4&5 to leave the main body 6. The retainer pin 13 and bearing washer 14 keeps the augar shaft 1 from leaving the slide body top plate 2 slide rail nuts 15 & 16 hold the slide rails 4&5 to the slide rail top plate 2.

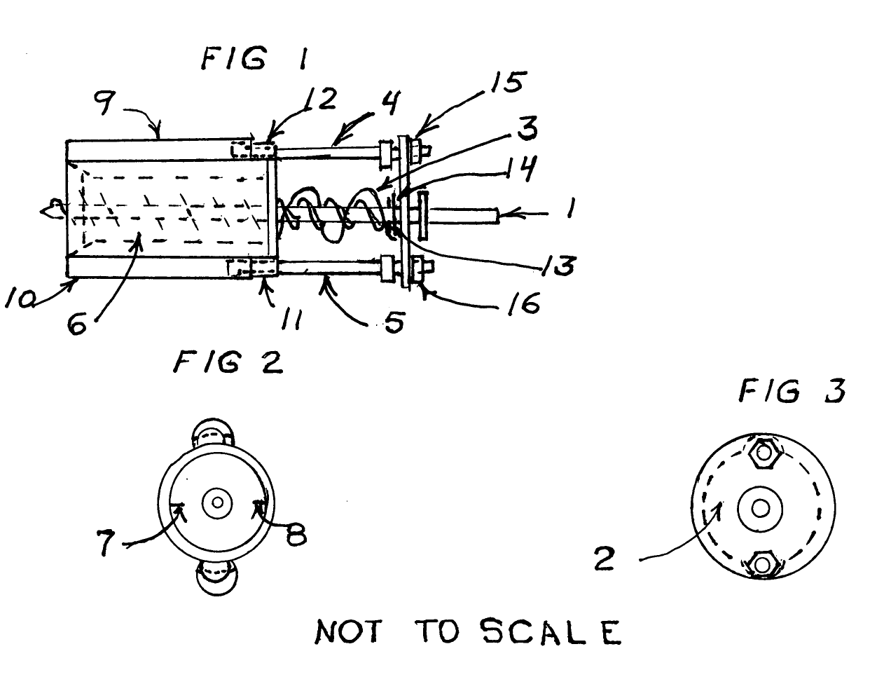

FIG. 1 is a side view of the total wine bottle opener.

FIG. 2 is a bottom view of the main body 3 looking from the wine bottle cork.

FIG. 3 is a view looking at the top of the augar shaft 1 and slide body top plate 2

A rotating power source is coupled to the top of the augar shaft 1 a clockwise motion is initiated. The augar shaft 1 is screwed thru the the cork with the permanent bearing surface of the augar shaft 1 pulling the slide body top plate 2 and slide rails 4 & 5 to the main body 6, compressing the compression spring 3, the rotation continues until the cork rides up the augar shaft, the cork holding rails 7 and 8 hold the cork from not turning with the augar shaft 1 the cork continues up the augar shaft 1 unit it is removed from the bottle. The main body 6 is then held or placed in a support and the rotation is reversed. The compression spring 3 pushes the main body 6 and slide body 2 and slide body rails 4 & 5 apart forcing the cork to screw off the augar shaft 1, slide rail housing 9 & 10 are installed to protect moving parts slide rail retainers 11 & 12, will not allow the L shaped slide rails 4 & 5 to leave the main body 6. The retainer pin 13 and bearing washer 14 keeps the augar shaft 1 from leaving the slide body top plate 2 slide rail nuts 15 &16 hold the slide rails 4 & 5 to the slide rail top plate 2.

This specification contains no new matter, only the addition of the description of the drawings. No additional pages are necessary.

What I claim my invention is:

1. I am utilizing power sources that may already be owned by almost everyone, it is low cost to manufacture, and it is simple, very few moving parts, and can be manufactured with a variety of materials, making the purchase within the means of almost anyone who enjoys a glass of wine.
